(19) United States
(12) Patent Application Publication
(10) Pub. No.: US 2026/0045405 A1
(43) Pub. Date: Feb. 12, 2026

(54) TRANSFORMER DEVICE

(71) Applicant: Lite-on Technology Corporation, Taipei (TW)

(72) Inventors: Yi-NAN HUANG, Taipei (TW); Yen- Yi Lee, Taipei (TW); Chien-Feng Huang, Taipei (TW); Sheng-Wen Huang, Taipei (TW)

(21) Appl. No.: 19/055,561

(22) Filed: Feb. 18, 2025

(30) Foreign Application Priority Data
Aug. 12, 2024 (TW) 113130149

(51) Int. Cl. H01F 27/30; H01F 30/06

(52) U.S. Cl. CPC H01F 27/303; H01F 27/306; H01F 30/06

(57) ABSTRACT

A transformer device is provided. The transformer device comprises a magnetic core group, a primary winding, a secondary winding and an adhesive member with magnetic permeability. The primary winding is disposed in the magnetic core group. The secondary winding is disposed in the magnetic core group. The adhesive member with magnetic permeability is disposed between the primary winding and the secondary winding.

### This application claims the benefit of Taiwan application Serial No. 113130149, filed on Aug. 12, 2024, the subject matter of which is incorporated herein by reference.

### TECHNICAL FIELD

The present invention relates to a transformer device, and in particular relates to a transformer device able to increase the leakage inductance.

### BACKGROUND

In the technical field regarding power supplies, as the volumetric power density of the power supply increases, the circuits therein require the leakage inductance of the transformer to resonate. The leakage inductance of a transformer is caused by the coupling between its primary winding and secondary winding. The degree of coupling is negatively correlated with the distance between the primary winding and the secondary winding. That is, the greater the distance between the primary winding and the secondary winding, the lower the degree of coupling, and conversely, the higher the leakage inductance. Therefore, if it is desired to increase the leakage inductance, it is needed to increase the volume of the transformer.

In view of this, those skilled in the art strive for how to increase the leakage inductance of the transformer without increasing the volume of the transformer.

### SUMMARY

The present invention relates to a new transformer device. By arranging an adhesive member with magnetic permeability between a primary winding and a secondary winding, the leakage inductance of the transformer device itself can be increased. As such, there is no need to increase a distance between the primary winding and the secondary winding, and thus a volume of the transformer device does not need to be increased.

According to an aspect of the present invention, a transformer device is provided. A transformer device is provided. The transformer device comprises a magnetic core group, a primary winding, a secondary winding and an adhesive member with magnetic permeability. The primary winding is disposed in the magnetic core group. The secondary winding is disposed in the magnetic core group. The adhesive member with magnetic permeability is disposed between the primary winding and the secondary winding.

The above summary is not intended to represent all embodiments or all aspects of the present invention. Rather, the foregoing summary merely provides examples that illustrate the novel aspects and features of the present invention. The above and other aspects of the present invention will become better understood with regard to the following detailed description of the preferred but non-limiting embodiment(s). The following description is made with reference to the accompanying drawings.

### BRIEF DESCRIPTION OF THE DRAWINGS

FIG. 1 is an exploded view of a transformer device according to a first embodiment of the present invention.

FIG. 2A is an exploded view of a transformer device according to a second embodiment of the present invention.

FIG. 2B is an assembly diagram of the transformer device according to the second embodiment of the present invention.

FIG. 3A is an exploded view of a transformer device according to a third embodiment of the present invention.

FIG. 3B is an assembly diagram of the transformer device according to the third embodiment of the present invention.

FIG. 4A is an exploded view of a transformer device according to a fourth embodiment of the present invention.

FIG. 4B is an assembly diagram of the transformer device according to the fourth embodiment of the present invention.

FIG. 5A is an exploded view of a transformer device according to a fifth embodiment of the present invention.

FIG. 5B is an assembly diagram of the transformer device according to the fifth embodiment of the present invention.

FIG. 6 is a schematic diagram of an adhesive member with magnetic permeability included in the transformer devices according to the embodiments of the present invention.

### DETAILED DESCRIPTION

Detailed descriptions of the embodiments of the specification are disclosed below with reference to the accompanying drawing. Apart from the said detailed descriptions, any embodiments in which the present invention can be used as well as any substitutions, modifications or equivalent changes of the said embodiments are within the scope of the disclosure, and the descriptions and definitions in the claims shall prevail. In the following detailed description, for purposes of explanation, numerous specific details are set forth in order to provide a thorough understanding of the disclosed embodiments. It will be apparent, however, that one or more embodiments may be practiced without these specific details. Additionally, well-known common steps or components are not described in detail to avoid unnecessarily limiting the present invention. The same or similar elements in the figures are represented by the same or similar sign.

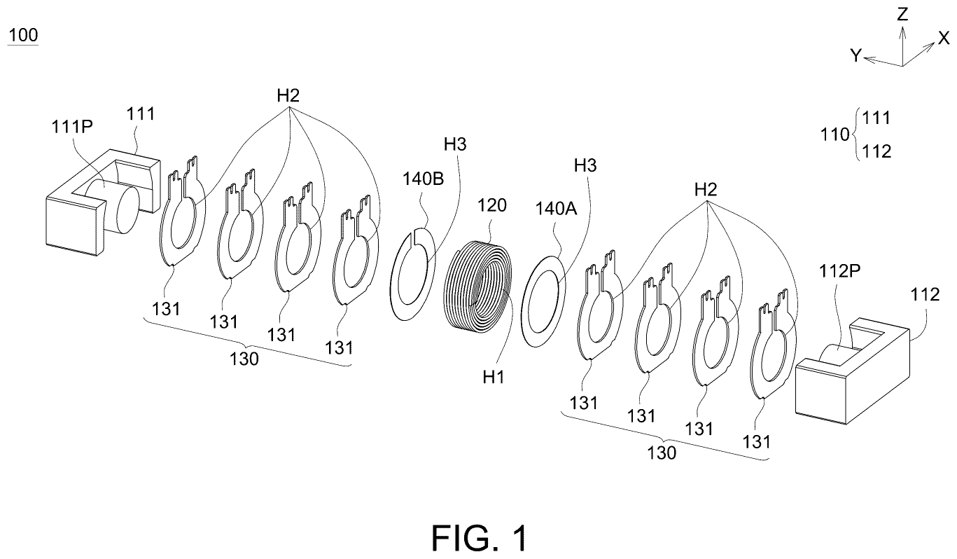

Please refer to FIG. 1, which illustrates an exploded view of a transformer device 100 according to a first embodiment of the present invention.

As shown in FIG. 1, the transformer device 100 in the first embodiment may comprise a magnetic core group 110, a primary winding 120, a secondary winding 130 and adhesive members with magnetic permeability 140A, 140B. The magnetic core group 110 may include a first magnetic core component 111 and a second magnetic core component 112. The first magnetic core component 111 and the second magnetic core component 112 are arranged symmetrically with each other. The primary winding 120 and the secondary winding 130 are both arranged on the magnetic core group 110.

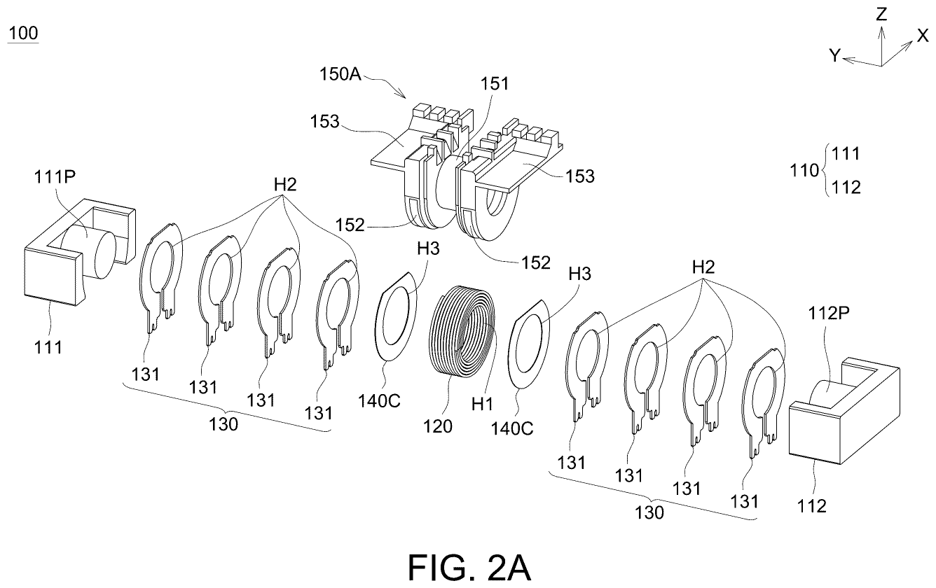

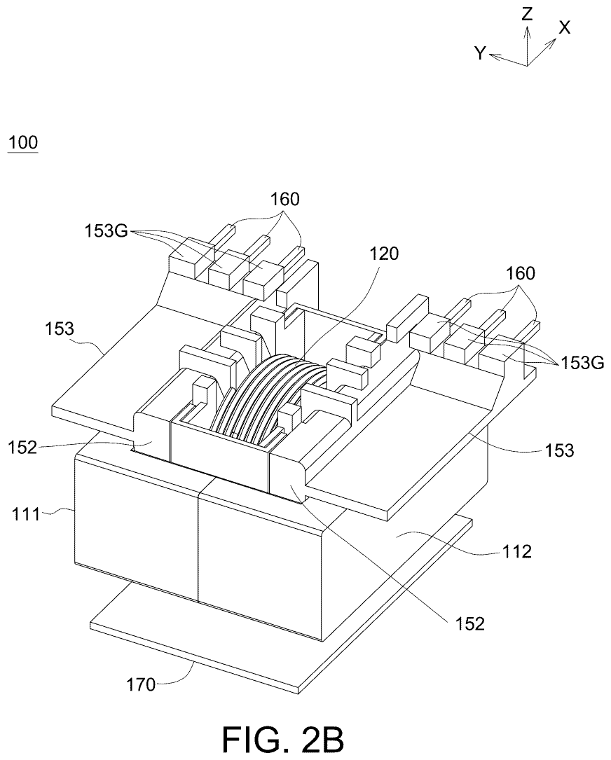

In this embodiment, two secondary windings 130 are disposed on both sides of the primary winding 120, and the adhesive members with magnetic permeability 140A, 140B are disposed between the primary winding 120 and the two secondary windings 130. As shown in FIG. 1, the adhesive member with magnetic permeability 140A (or the adhesive member with magnetic permeability 140B) is disposed between the primary winding 120 and the secondary winding 130 which is adjacent to the second magnetic core component 112, and the adhesive member with magnetic permeability 140B (or the adhesive member with magnetic permeability 140A) is disposed between the primary winding 120 and the secondary winding 130 which is adjacent to the first magnetic core component 111. That is, the adhesive members with magnetic permeability 140A, 140B may be attached to the primary winding 120 or the secondary winding 130. In another embodiment, an adhesive member with magnetic permeability 140C as shown in FIG. 2A may also be used and attached to the primary winding 120 or the secondary winding 130.

For example, the adhesive members with magnetic permeability 140A, 140B and 140C are all attached to the primary winding 120. Or, the adhesive members with magnetic permeability 140A, 140B and 140C are attached to their respective adjacent secondary windings 130. Or, any one of the adhesive members with magnetic permeability 140A, 140B and 140C is attached to the primary winding 120, and another one of the adhesive members with magnetic permeability 140A, 140B and 140C is attached to its adjacent secondary winding 130. Therefore, the adhesive members with magnetic permeability 140A, 140B and 140C are attached to either the primary winding 120 or the secondary winding 130 without limitation.

In an embodiment, the primary winding 120 may be a coil winding, a single secondary winding 130 may include a plurality of stacked metal sheet members 131, and the adhesive members with magnetic permeability 140A, 140B are annular structures. In detail, the adhesive member with magnetic permeability 140A and the adhesive member with magnetic permeability 140B have different shapes. The adhesive member with magnetic permeability 140A is a closed annular structure, while the adhesive member with magnetic permeability 140B is an open annular structure with a notch. In other embodiments, the same two adhesive members with magnetic permeability 140A or the same two adhesive members with magnetic permeability 140B may be used as the adhesive member with magnetic permeability attached to the primary winding 120 or the secondary winding 130. That is, it is not necessary to use the adhesive member with magnetic permeability 140A and the adhesive member with magnetic permeability 140B at the same time.

In an embodiment, the coil winding being the primary winding 120 forms a perforation H1 at its interior, each of the metal sheet members 131 forms a perforation H2 at its center, and the adhesive members with magnetic permeability 140A and 140B, which have annular structures, form perforations H3. The magnetic core group 110 can pass through these perforations H1, H2 and H3 so as to arrange the primary winding 120, the secondary winding 130 and the adhesive members with magnetic permeability 140A and 140B thereon.

Specifically, in the magnetic core group 110, the first magnetic core component 111 and the second magnetic core component 112 located on the left and right sides may respectively have a first protruding column 111P and a second protruding column 112P. When the first protruding column 111P and the second protruding column 112P are assembled, the top surfaces of these two protruding columns are connected to form a shaft portion (parallel to the Y-axis direction of FIG. 1). The first protruding column 111P and the second protruding column 112P pass through the primary winding 120, the secondary winding 130 and the adhesive members with magnetic permeability 140A and 140B, so that the primary winding 120, the secondary winding 130 and the adhesive members with magnetic permeability 140A and 140B can be mounted on the aforementioned shaft portion. In this embodiment, when the transformer device 100 is assembled, the adhesive members with magnetic permeability 140A and 140B may be in contact with the primary winding 120 and its adjacent secondary winding 130 at the same time, so as to strengthen the fixation of the adhesive members with magnetic permeability in the transformer device.

Please refer to FIGS. 2A and 2B, which illustrate an exploded view and an assembly diagram of the transformer device 100 according to a second embodiment of the present invention. The transformer device 100 of the second embodiment comprises a magnetic core group 110, a primary winding 120, and a secondary winding 130. Implementation details of these elements similar to or the same as those described above may be adopted and will not be described again. The following description focuses on the distinguishing features of this second embodiment.

Similarly, the transformer device 100 of the second embodiment comprises adhesive members with magnetic permeability 140C. The two adhesive members with magnetic permeability 140C disposed on both sides of the primary winding 120 have the same shape, with a closed annular structure with one end being a straight line.

Compared with the first embodiment, the transformer device 100 of the second embodiment may further comprise a coil bobbin 150A, wherein the coil bobbin 150A is enclosed by the first magnetic core component 111 and the second magnetic core component 112 after they are assembled. The coil bobbin 150A includes a winding shaft portion 151 and an accommodating portion 152 which are connected. The number of the winding shaft portion 151 is configured to correspond to that of the primary winding 120. The number of the accommodating portion 152 is configured to correspond to that of the secondary winding 130.

In an embodiment, a single winding shaft portion 151 may be used for the primary winding 120 to be wound, namely the primary winding 120 can be mounted on the winding shaft portion 151. Also, two ends of the winding shaft portion 151 are connected to two accommodating portions 152 respectively, so that two secondary windings 130 can be respectively disposed in two accommodating portions 152. Specifically, the accommodating portion 152 is a disc-slot structure, and the secondary winding 130 formed by a plurality of stacked metal sheet members 131 can be accommodated in this disc-slot structure.

In an embodiment, two adhesive members with magnetic permeability 140C are respectively adhered to two secondary windings 130, and are accommodated in the disc-slot structure of the accommodating portion 152 together with the secondary windings 130 to which they are adhered. That is, when the adhesive member with magnetic permeability 140C is attached to the secondary winding 130, the adhesive member with magnetic permeability 140C is disposed in the accommodating portion 152. However, in other embodiments, if only the aforementioned adhesive member with magnetic permeability 140B is used, the adhesive member with magnetic permeability 140B can be fixed on the primary winding 120. Since the adhesive member with magnetic permeability 140B has a notch, the adhesive member with magnetic permeability 140B can pass through the winding shaft portion 151 together with the primary winding 120 and be attached to the primary winding 120. In a design that the transformer device 100 further comprises a coil bobbin 150A, the primary winding 120 and the secondary winding 130 are separated by the coil bobbin 150A and are not in contact. As such, the adhesive member with magnetic permeability can be disposed at different positions of the coil bobbin 150A in response to it attached to the primary winding 120 accordingly (when only the adhesive member with magnetic permeability 140B is used) or the secondary winding 130 (when the adhesive members with magnetic permeability 140A, 140B and 140C are used).

In an embodiment, as shown in FIG. 2B, the transformer device 100 may include a plurality of pins 160, and the coil bobbin 150A further includes two lead portions 153 arranged symmetrically with each other. These two lead portions 153 have a plurality of pin slots 153G, and the pins 160 may be respectively arranged in the plurality of pin slots 153G of the lead portions 153. The primary winding 120 can be selectively connected to any two of the pins 160 through lead wires (not shown in the drawing) according to actual usage requirements.

In an embodiment, the lead portions 153 are plate-like structures extending horizontally (parallel to the direction of X-Y plane of FIG. 2B), so that the pin slots 153G are spaced apart along a direction parallel to the axis direction of the winding shaft portion 151 of the coil bobbin 150A (that is, parallel to Y-axis direction of FIG. 2B). In addition, the transformer device 100 may also comprise a circuit board 170, and the secondary winding 130 is connected to the circuit board 170. The circuit board 170 is, for example, a printed circuit board (PCB).

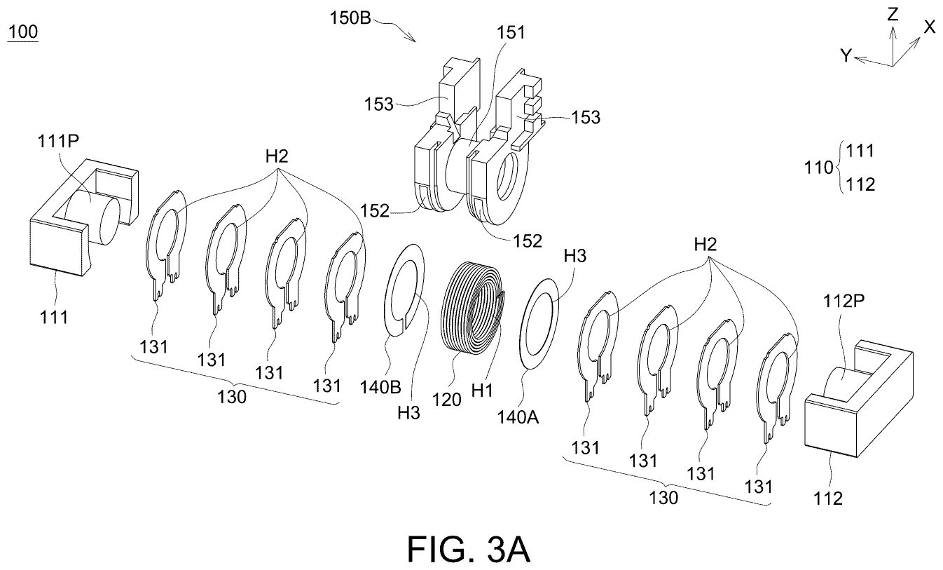

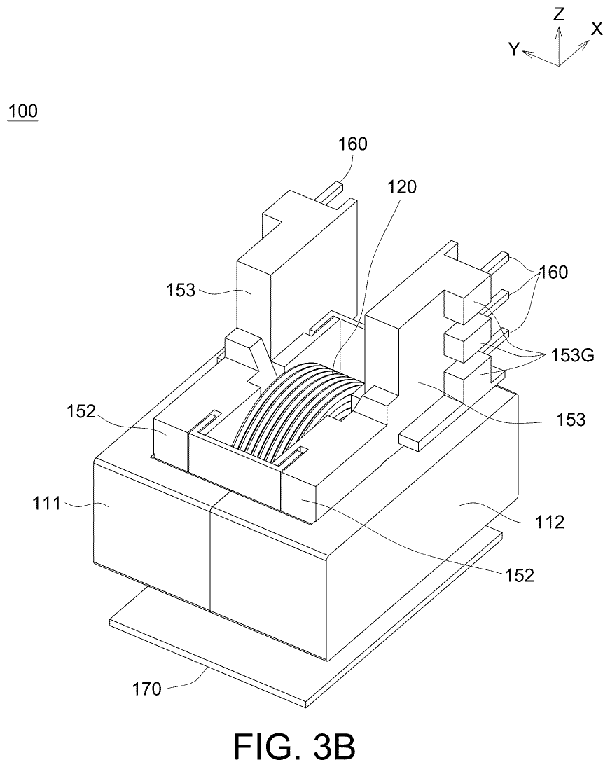

Please refer to FIGS. 3A and 3B, which illustrate an exploded and an assembly diagram of the transformer device 100 according to a third embodiment of the present invention. The transformer device 100 of the third embodiment comprises a magnetic core group 110, a primary winding 120, a secondary winding 130, and adhesive members with magnetic permeability 140A, 140B and 140C. Implementation details of these elements similar to or the same as those described above may be adopted, and will not be described again. The following description focuses on the distinguishing features of this second embodiment.

Similar to the second embodiment, the transformer device 100 of the third embodiment may further comprise a coil bobbin 150B, and the coil bobbin 150B serves the same purpose as the coil bobbin 150A. Both of them have a single winding shaft portion 151 for the primary winding 120 to be wound on, and have two accommodating portions 152 connected at two ends of the winding shaft portion 151, allowing two secondary windings 130 to be respectively arranged in them. After the first magnetic core component 111 and the second magnetic core component 112 are assembled, the coil bobbin 150B is enclosed by the first magnetic core component 111 and the second magnetic core component 112.

In an embodiment, the adhesive members with magnetic permeability 140A and 140B are respectively adhered to their respective adjacent secondary windings 130, and are accommodated in a disc-slot structure of the accommodating portions 152 on both sides together with the secondary windings 130 adhered thereto.

Compared with the second embodiment, the main difference lies in the structure of the lead portion 153 of the coil bobbin 150B. Specifically, the lead portions 153 of the coil bobbin 150B is a plate-like structure extending vertically (parallel to the direction of X-Z plane of FIG. 3B), so that the pin slots 153G are spaced apart along a direction perpendicular to the axis direction of winding shaft portion 151 of the coil bobbin 150B (that is, parallel to Z-axis direction of FIG. 3B), thereby reducing the finished product volume of the transformer device 100. Similarly, as shown in FIG. 3B, the transformer device 100 of the third embodiment may also comprise a circuit board 170, and the secondary winding 130 is connected to the circuit board 170.

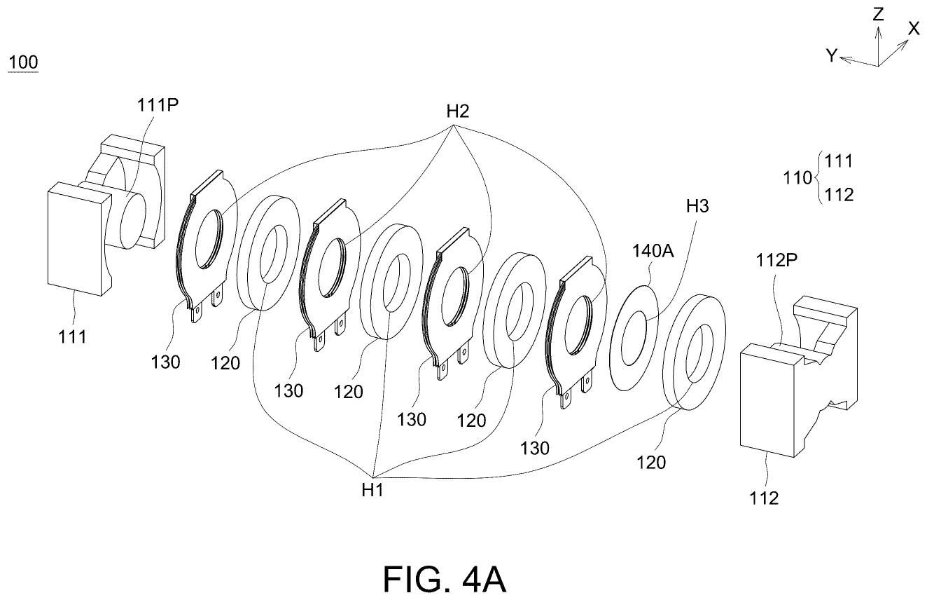

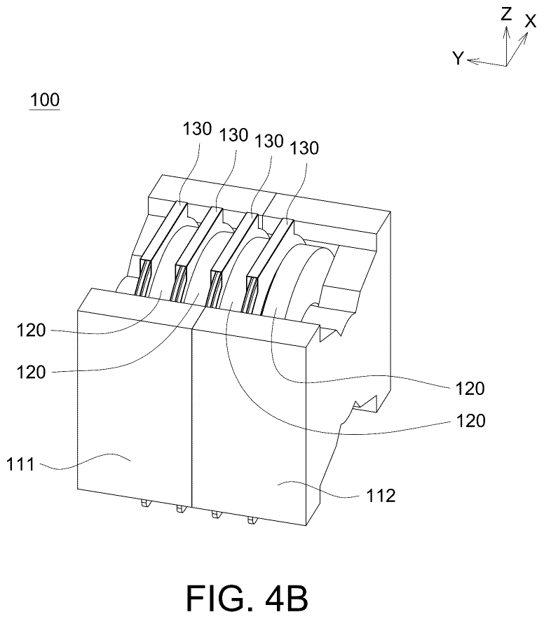

Please refer to FIGS. 4A and 4B, which illustrate an exploded view and an assembly diagram of the transformer device 100 according to a fourth embodiment of the present invention. The transformer device 100 of the fourth embodiment comprises a magnetic core group 110, a primary winding 120, a secondary winding 130 and an adhesive member 140A with magnetic permeability (the adhesive members 140A with magnetic permeability 140B and 140C may also be used). Implementation details of these elements similar to or the same as those described above may be adopted, and will not be described again. The following description focuses on the distinguishing features of this second embodiment.

In this embodiment, there are multiple primary windings 120 and the secondary windings 130, and they are arranged alternately. A plurality of primary windings 120 and a plurality of secondary windings 130 are arranged alternately and are in front-to-back contact. One primary winding 120 and one secondary winding 130 constitute one winding group. That is, there are four winding groups as shown in FIGS. 4A and 4B, but the present invention is not limited thereto and the number of winding groups may be increased or decreased according to practical needs. The primary winding 120 may be connected to other devices or circuits through the jump wire. The secondary winding 130 may also be connected to a circuit board (not shown in the drawing).

In an embodiment, the winding groups composed of the primary windings 120 and the secondary windings 130 are arranged in series in the magnetic core group 110. The first magnetic core component 111 and the second magnetic core component 112 pass through and clamps these winding groups, so as to fix the winding groups in the magnetic core group 110.

As shown in FIG. 4A, a single adhesive member with magnetic permeability 140A is disposed in one of the winding groups, but it is not limited thereto. In other embodiments, some winding groups may be provided with the adhesive member with magnetic permeability 140A (the adhesive members with magnetic permeability 140A, 140B and 140C may also be used); or each winding group may be provided with the adhesive member with magnetic permeability 140A. In addition, the adhesive member with magnetic permeability 140A can also be provided between the winding groups, that is, there may be multiple the adhesive members with magnetic permeability 140A, and one adhesive member with magnetic permeability 140A is disposed between every two winding groups.

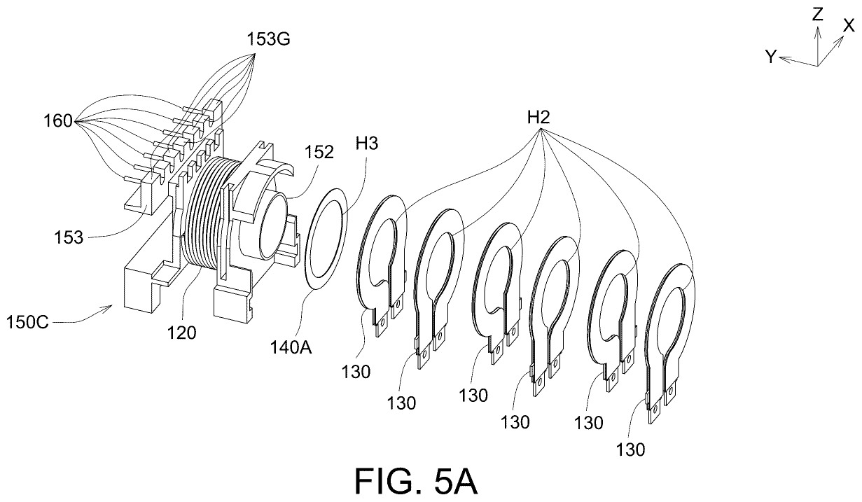

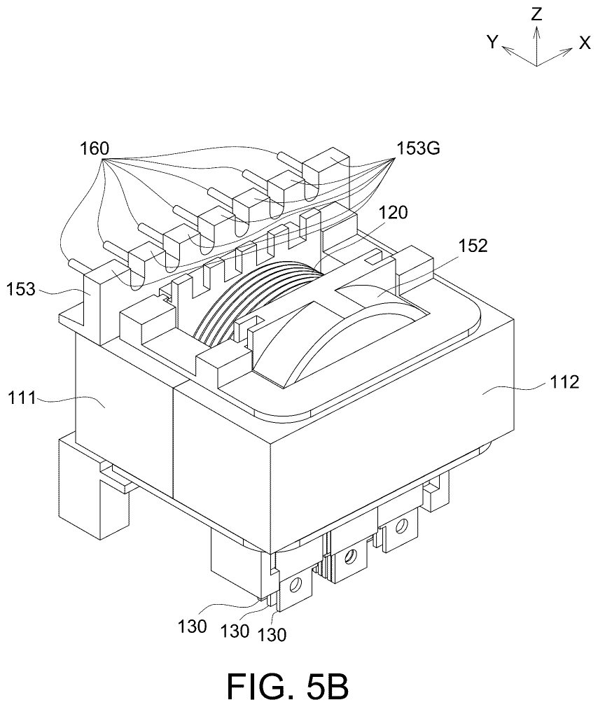

Please refer to FIGS. 5A and 5B, which illustrate an exploded view and an assembly diagram of the transformer device 100 according to a fifth embodiment of the present invention, wherein the magnetic core group 110 is omitted in FIG. 5A. The transformer device 100 of the fifth embodiment comprises a magnetic core group 110, a primary winding 120, a secondary winding 130 and an adhesive member with magnetic permeability 140A. Implementation details of these elements similar to or the same as those described above may be adopted, and will not be described again. The following description focuses on the distinguishing features of this fifth embodiment.

Similar to the second embodiment and the third embodiment, the transformer device 100 of the fifth embodiment may further comprise a coil bobbin 150C to separate the primary winding 120 and the secondary winding 130, so that they are not in contact. In this embodiment, the coil bobbin 150C has similar purpose to the coil bobbin 150A and the coil bobbin 150B. The coil bobbin 150C has a single winding shaft portion 151 for the primary winding 120 to be wound on, and has a single accommodating portion 152 connected at one end of the winding shaft portion 151 for the secondary winding 130 to be arranged in. After the first magnetic core component 111 and the second magnetic core component 112 are assembled, the coil bobbin 150C is enclosed by the first magnetic core component 111 and the second magnetic core component 112. However, the accommodating portion 152 of the coil bobbin 150C is not a disc-slot structure, but a hollow barrel-shaped structure. This hollow barrel-shaped structure can pass through the adhesive member with magnetic permeability 140A (the adhesive members with magnetic permeability 140B and 140C can also be used) and the secondary winding 130 for fixation. In this embodiment, the adhesive member with magnetic permeability 140A can be adhered to its adjacent secondary winding 130 and, together with the adhered secondary winding 130, pass through and be mounted on the hollow barrel-shaped structure of the accommodating portion 152.

In an embodiment, a lead portion 153 is provided at a side corresponding to the accommodating portion 152 of the coil bobbin 150C. The lead portion 153 of the coil bobbin 150C is a plate-like structure formed along a direction perpendicular to the axis direction (parallel to Y-axis direction of FIGS. 3A and 3B) of the winding shaft portion 151 of the coil bobbin 150C, so that the pin slots 153G of the lead portion 153 are spaced apart along the same direction (parallel to X-axis direction of FIGS. 3A and 3B). The pins 160 can be respectively provided in these pin slots 153G. The primary winding 120 can be selectively connected to any two of the pins 160 through lead wires (not shown in the drawing) according to actual use requirements. As such, the structure of the transformer device 100 of the fifth embodiment can provide different pin directions from the second and third embodiments.

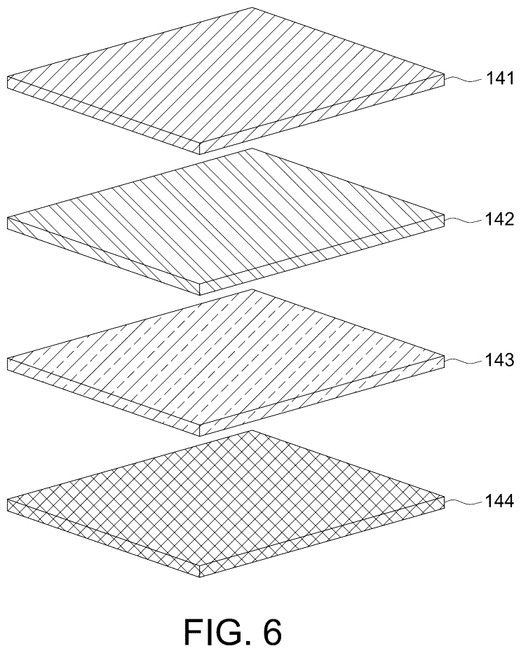

FIG. 6 is a schematic diagram of an adhesive member with magnetic permeability included in the transformer devices 100 according to all embodiments of the present invention.

The adhesive members with magnetic permeability 140A, 140B and 140C as mentioned above may each include an insulating layer 141, a magnetic layer 142, an adhesive layer 143 and a release layer 144. The insulating layer 141 is, for example, a polyethylene terephthalate (PET) film. The magnetic layer 142 is, for example, made of an iron-based alloy with a nanocrystalline structure. The adhesive layer 143 is, for example, PET tape. The release layer 144 is, for example, a PET single-sided release film. The release layer 144 will be torn off when the transformer device 100 is assembled, so that the adhesive members with magnetic permeability 140A, 140B, and 140C can be attached to the primary winding 120 or the secondary winding 130 through the adhesive layer 143. That is, each of the adhesive members with magnetic permeability 140A, 140B, and 140C is a composite laminated material. In an embodiment, the stack thickness of the insulating layer 141, the magnetic layer 142 and the adhesion layer 143 may be less than 1 mm.

Further, the insulating layer 141, the magnetic layer 142 and the adhesive layer 143 are all elastic and flexible, so that the adhesive members with magnetic permeability 140A, 140B and 140C are bendable structures, so as to adapt to the setting environment of the primary winding 120 or the secondary winding 130 attached thereto. In another embodiment, on the premise that the overall thickness of the adhesive member with magnetic permeability 140A, 140B or 140C is less than 1 mm, the magnetic layer 142 is not limited to a single layer. That is, the magnetic layer 142 can consist of multiple layers. The magnetic layers 142 are stacked on and bonded to each other. Therefore, when the transformer device 100 is operating, the adhesive members with magnetic permeability 140A, 140B and 140C generate the leakage inductance through the magnetic interference of the magnetic layer 142 thereof.

According to the above description, the present invention provides a new transformer device, which increases its leakage inductance by disposing the adhesive member with magnetic permeability between the primary winding and the secondary winding. As such, there is no need to increase a distance between the primary winding and the secondary winding, and thus a volume of the transformer device does not need to be increased. Thus, a size of the transformer device can be reduced.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A transformer device, comprising:
a magnetic core group;
at least one primary winding, disposed in the magnetic core group;
at least one secondary winding, disposed in the magnetic core group; and
at least one adhesive member with magnetic permeability, disposed between the primary winding and the secondary winding.

2. The transformer device of claim 1, wherein the at least one adhesive member with magnetic permeability includes an insulating layer, at least one magnetic layer, and an adhesive layer which are stacked, and the at least one adhesive member with magnetic permeability is attached to the at least one primary winding or the at least one secondary winding through the adhesive layer.

3. The transformer device of claim 1, wherein the at least one secondary winding includes a plurality of metal sheet members, each of the plurality of metal sheet members has a perforation at their center, and the magnetic core group passes through the perforations.

4. The transformer device of claim 1, wherein the at least one primary winding is a coil winding, the coil winding forms a perforation at its interior, and the magnetic core group passes through the perforation.

5. The transformer device of claim 1, wherein the at least one adhesive member with magnetic permeability is an annular structure with a perforation at its center, and the magnetic core group passes through the perforation.

6. The transformer device of claim 1, wherein the magnetic core group includes a first magnetic core and a second magnetic core which are arranged symmetrically, each of the first magnetic core and the second magnetic core has a protruding column at their interior, the two protruding columns form a shaft portion, and the at least one primary winding, the at least one secondary winding and the at least one adhesive member with magnetic permeability are mounted on the shaft portion.

7. The transformer device of claim 1, further comprising a coil bobbin, wherein the coil bobbin includes at least one winding shaft portion and at least one accommodating portion which are connected, the at least one primary winding wound on the at least one winding shaft portion, the at least one secondary winding disposed in the at least one accommodating portion, and the at least one primary winding and the at least one secondary winding are not in contact.

8. The transformer device of claim 7, wherein when the at least one adhesive member with magnetic permeability is attached to the at least one primary winding, the at least one adhesive member with magnetic permeability is mounted on the winding shaft portion.

9. The transformer device of claim 7, wherein when the at least one adhesive member with magnetic permeability is attached to the at least one secondary winding, the at least one adhesive member with magnetic permeability is disposed in the at least one accommodation portion.

10. The transformer device of claim 7, wherein the transformer device includes a plurality of pins, and wherein the coil bobbin further includes at least one lead portion having a plurality of pin slots, and the plurality of pins are respectively disposed in the plurality of pin slots.

11. The transformer device of claim 10, wherein the plurality of pin slots are spaced apart along a direction parallel to an axis direction of the winding shaft portion.

12. The transformer device of claim 10, wherein the plurality of pin slots are spaced apart along a direction perpendicular to an axis direction of the winding shaft portion.

13. The transformer device of claim 1, wherein a plurality of the primary windings and a plurality of the secondary windings are included, one said primary winding and one said secondary winding constitute one winding group, the winding groups are arranged in series in the magnetic core group, and the at least one adhesive member with magnetic permeability is disposed on at least one of the winding groups.

14. The transformer device of claim 13, wherein a plurality of the adhesive members with magnetic permeability are included, one said adhesive member with magnetic permeability is disposed between every two said winding group.

15. The transformer device of claim 2, wherein a stack thickness of the insulating layer, the at least one magnetic layer and the adhesive layer is less than 1 mm.

16. The transformer device of claim 1, wherein the at least one adhesive member with magnetic permeability is a bendable structure.

17. The transformer device of claim 2, wherein a plurality of the magnetic layers are included, and said magnetic layers are stacked on each other.
